(19) United States
(12) Patent Application Publication
(10) Pub. No.: US 2013/0146631 A1
(43) Pub. Date: Jun. 13, 2013

(54) VEHICLE-MOUNTED HOLDER

(71) Applicant: Beat-Sonic Co., Ltd., Nisshin-shi (JP)

(72) Inventor: Tsutomu TOTANI, Nisshin-shi (JP)

(73) Assignee: BEAT-SONIC CO., LTD., Nisshin-shi (JP)

(21) Appl. No.: 13/685,856

(22) Filed: Nov. 27, 2012

(30) Foreign Application Priority Data
Dec. 12, 2011 (JP) 2011-271099

(51) Int. Cl. B60R 11/02

(52) U.S. Cl. CPC B60R 11/0205
USPC 224/545

(57) ABSTRACT

A vehicle-mounted holder includes a C-shaped bracket including right and left or upper and lower insertion pieces and a connection piece connecting between the insertion pieces and a joint having two ends, one of which is fixed to a surface of the connection piece and to the other of which a holding member holding a communication device is detachably attachable. The joint is capable of adjusting a direction of the holding member between an up-down direction and right-left direction. The bracket has width and height both set according to width and height of a recess located in vehicle dashboard for installation of car audio equipment having standardized width and height so that the right and left insertion pieces can be secured to right and left walls of the recess or so that the upper and lower insertion pieces can be secured to upper and lower walls of the recess, respectively.

### CROSS-REFERENCE TO RELATED APPLICATIONS

This application is based upon and claims the benefit of priority from the prior Japanese Patent Application No. 2011-271099 filed on Dec. 12, 2011, the entire contents of which are incorporated herein by reference.

### BACKGROUND

1. Technical Field

The present disclosure relates to a vehicle-mounted holder, and more particularly to such a vehicle-mounted holder usable to install a portable communication device in a vehicle interior, the portable communication device including smartphones, digital cameras, portable navigation devices, small TV monitors and tablet personal computers.

2. Related Art

A holder provided with a sucker or a stay has conventionally been used to install a portable communication device in a vehicle interior. The holder is fixed to a dashboard by the sucker, or the stay is inserted between louvers of an air conditioner outlet on the dashboard so that the holder is fixed.

When a portable communication device is installed on the vehicle dashboard using a conventional holder, a holder and/or the portable communication device needs to be installed so as not to block driver's or passenger's view. This limits an installation place for the holder on the dashboard.

Furthermore, mounting the holder on the louvers by the use of the stay would result in a defect that a flow of air from the air conditioner may be blocked by the holder and/or the communication device.

Furthermore, when the holder is mounted on the dashboard by the use of the sucker, an adsorption power of the sucker would be reduced since a surface of the dashboard is curved or rugged, whereupon there is a possibility that the holder may drop off. On the other hand, when a sucker with a higher adsorption power is used in order that the holder may be prevented from dropout of the holder from the dashboard, the sucker sometimes leaves its mark on the surface of the dashboard or sometimes damages the dashboard.

### SUMMARY

Therefore, an object of the present disclosure is to provide a vehicle-mounted holder which can be installed on the vehicle dashboard without blocking driver's view or a flow air from the air conditioner and damage to the dashboard.

The present disclosure provides a vehicle-mounted holder comprising a C-shaped bracket including a pair of right and left or upper and lower insertion pieces and a connection piece connecting between the insertion pieces; and a joint having two ends, one of which is fixed to a surface of the connection piece and to the other of which a holding member holding a communication device is detachably attachable, the joint being capable of adjusting a direction of the holding member between an up-down direction and a right-left direction, wherein the bracket has a width and a height both of which are set according to a width and a height of a recess provided in a dashboard of a vehicle for installation of car audio equipment having standardized width and height so that the right and left insertion pieces of the bracket can be secured to right and left walls of the recess or so that the upper and lower insertion pieces of the bracket can be secured to upper and lower walls of the recess, respectively.

Almost all passenger vehicles employ dashboards formed with car audio equipment accommodation recesses having sizes complying with a 1DIN or 2DIN size of the German Industry Standard (Deutsch Industrie Normen (DIN)). The recess complying with the 1DIN size has a width of 180 mm and a height of 50 mm and the recess complying with the 2DIN size has a width of 180 mm and a height of 100 mm. On the other hand, portable communication devices recently offered in the market, such as smartphones or tablet personal computers, can perform functions of car audio equipment. Accordingly, when the communication device of the above-described type is installed in the vehicle interior, radiocast or music can be listened to without provision of genuine car audio equipment. The vehicle-mounted holder has been made in view of the aforementioned circumstances.

According to the above-described vehicle-mounted holder, the bracket has the width and the height set according to the width and the height of the accommodation recess complying with 1DIN or 2DIN size. Consequently, the vehicle-mounted holder can be mounted in the recess from which genuine car audio equipment has been detached. Since the recess with the standardized size is originally disposed so that driver's view and flow of air from the air conditioner can be prevented from being blocked, the vehicle-mounted holder can be mounted in the recess.

In an embodiment, the recess has a front opening, and the connection piece has a width and a height both of which are set so that the opening of the recess is covered with the connection piece.

Since the opening of the recess is covered with the connection piece, the opening is prevented from being exposed even when car audio equipment is detached from the recess. Consequently, the visual quality of the dashboard can be prevented from being degraded.

In another embodiment, the joint has a pair of right and left or upper and lower through holes; the connection piece has a plurality of screw holes arranged along a widthwise or heightwise direction thereof; the joint is fixed to the connection piece by screwing a pair of screws through the through holes of the joint into the screw holes of the connection piece respectively; and the screw holes into which the screws are to be screwed are selected so that an attachment position of the joint to the connection piece is adjustable in a right-left direction or in an up-down direction.

An installation position of the communication device can be adjusted by adjustment of an attachment position of the joint.

### BRIEF DESCRIPTION OF THE DRAWINGS

In the accompanying drawings:

FIG. 1 illustrates a dashboard provided with a car audio equipment accommodation recess in which the car audio equipment is mounted and which is complying with the 2DIN size;

FIG. 2 illustrates the dashboard with the car audio equipment accommodation recess from which the car audio equipment has been detached;

FIG. 3 illustrates the dashboard with the car audio equipment accommodation recess in which the vehicle-mounted holder according to a first embodiment is mounted;

FIG. 4 illustrates the vehicle-mounted holder mounted in the accommodation recess complying with the 2DIN size;

FIG. 5 is a partially sectional side view of the vehicle-mounted holder;

FIG. 6 is a perspective view of a holding member which is detachably attached to the vehicle-mounted holder;

FIG. 7 illustrates a dashboard provided with a car audio equipment accommodation recess in which the car audio equipment is mounted and which is complying with the 1DIN size;

FIG. 8 illustrates the dashboard with the car audio equipment accommodation recess from which the car audio equipment has been detached;

FIG. 9 illustrates the dashboard with the car audio equipment accommodation recess in which the vehicle-mounted holder according to a second embodiment is mounted;

FIG. 10 is a side view of the vehicle-mounted holder of the second embodiment; and

FIG. 11 is a side view of the vehicle-mounted holder of a third embodiment.

### DETAILED DESCRIPTION

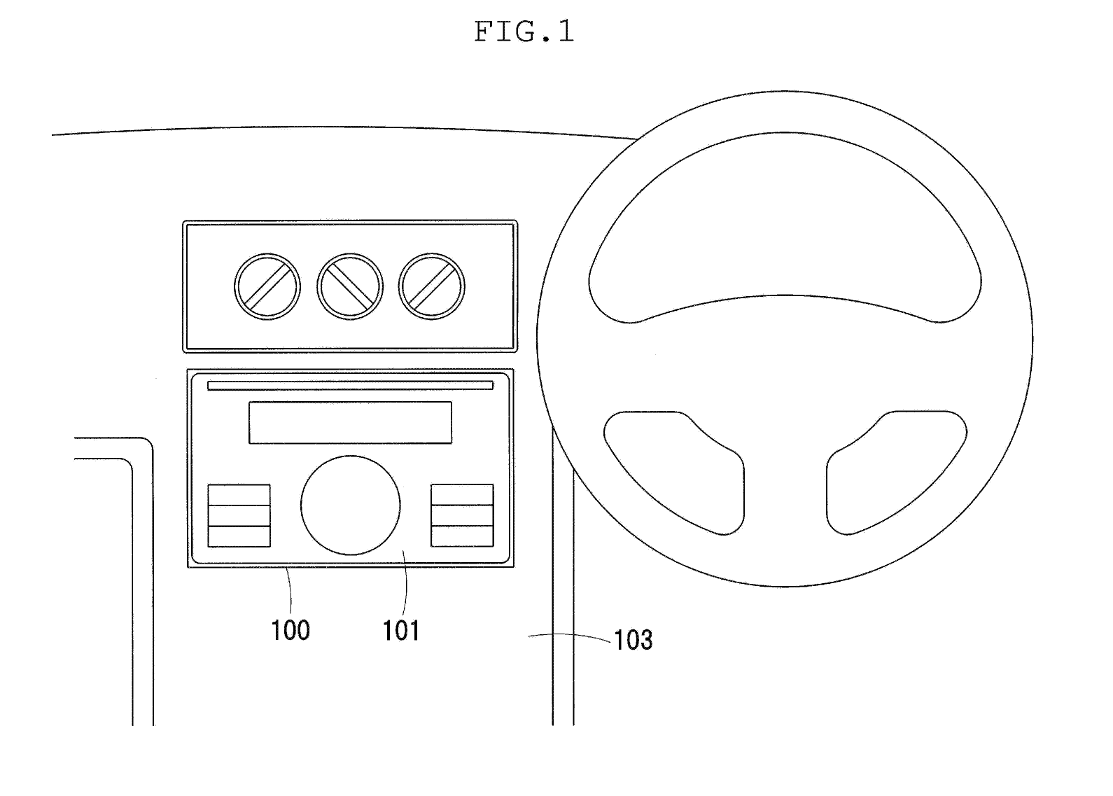

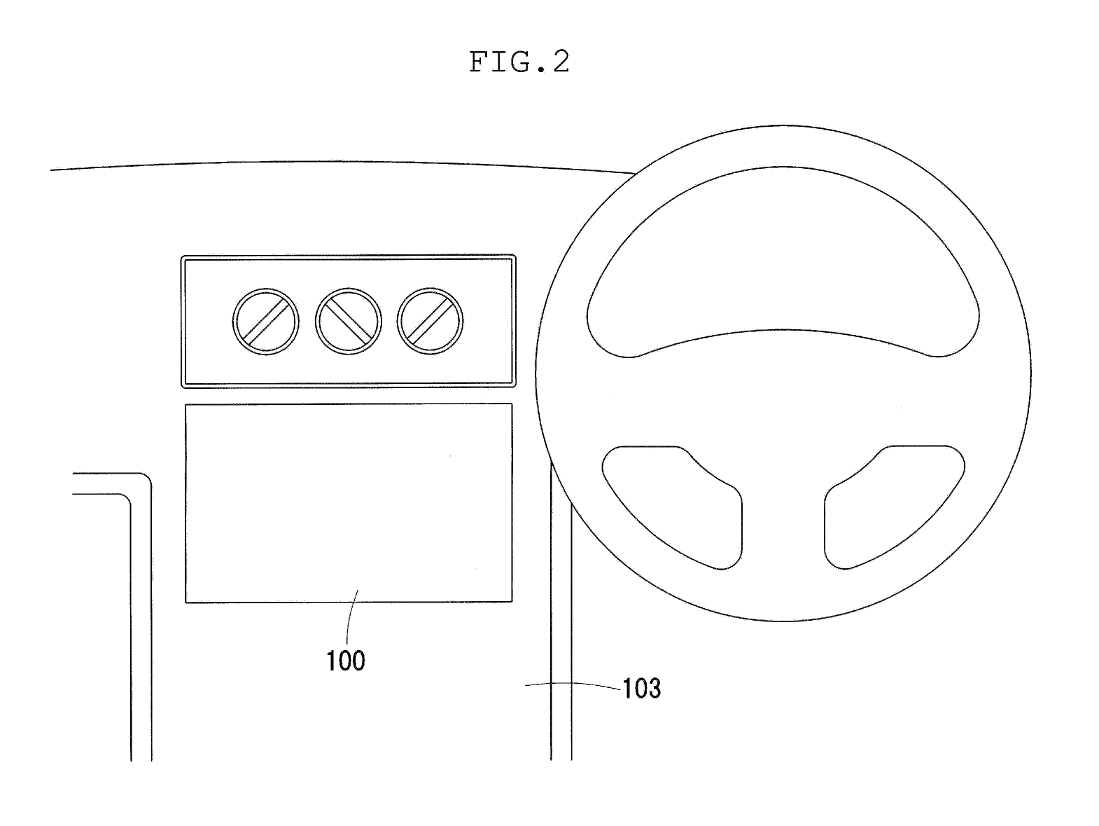

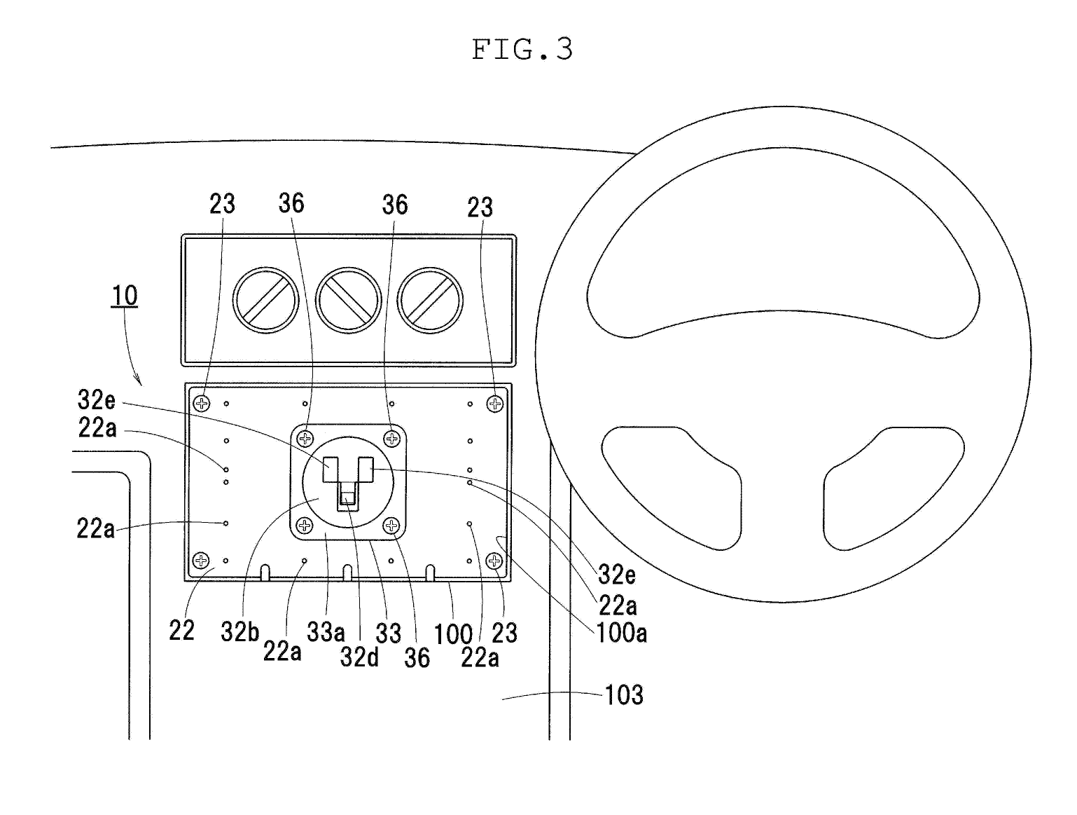

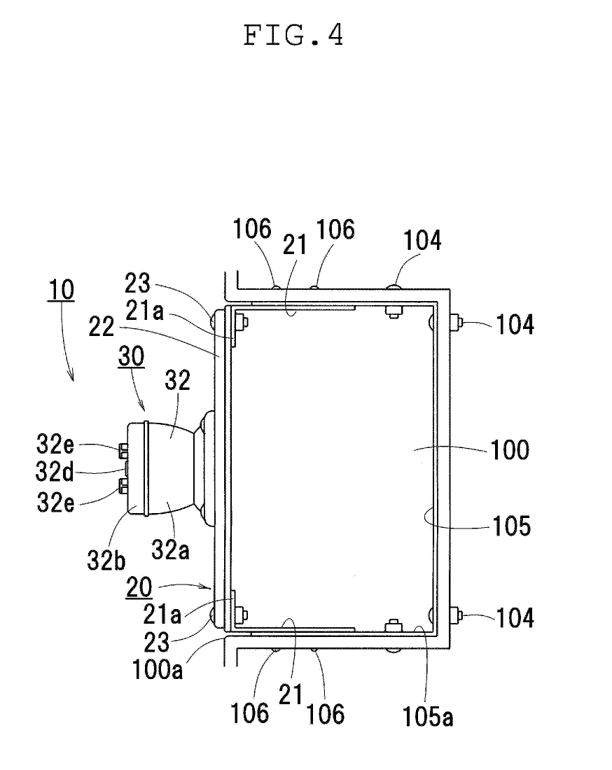

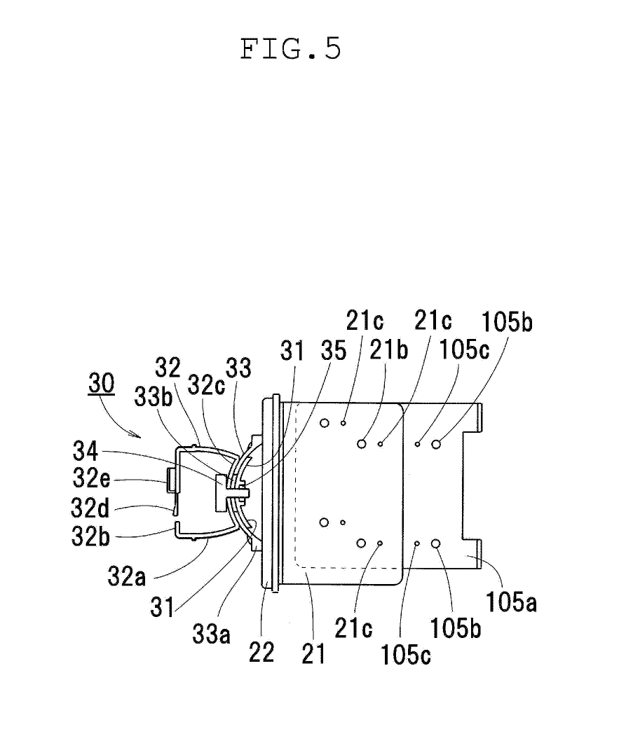

Several embodiments will be described with reference to the accompanying drawings. FIG. 1 shows a vehicle's dashboard 103 having a car audio equipment accommodation recess 100 which complies with the 2DIN size and in which car audio equipment 101 is mounted. FIG. 2 shows the dashboard 103 having the recess 100 from which the car audio equipment 101 has been detached. FIGS. 3 to 5 show s a vehicle-mounted holder 10 of a first embodiment, mounted in the recess 100 complying with the 2DIN size.

The vehicle-mounted holder 10 includes a generally C-shaped bracket 20 and a joint 30. The C-shaped bracket 20 includes a pair of right and left insertion pieces 21 and a connection piece 22 connecting between the insertion pieces 21. The insertion pieces 21 have ends that are bent at right angles, and the bent portions are fixed to right and left ends of the connection piece 22 by small screws 23, respectively. Each insertion piece 21 is formed with a plurality of, for example, four pairs of screw holes 21b and positioning small holes 21c.

The connection piece 22 has a number of screw holes 22a arranged at predetermined intervals in the right-left direction and in an up-down direction with respect to the connection piece 22. The connection piece 22 has a width and a height both of which are set so that the connection piece 22 can be accommodated in the recess 100 complying with the 2DIN size and cover a front opening 100a of the recess 100.

The joint 30 includes an inner curved member 31, an outer curved member 32, a guide piece 33, a bolt 34 and a nut 35. The inner and outer curved members 31 and 32 and the guide piece 33 are molded from resin. The inner curved member 31 is formed into the shape of a curved surface composing a part of spherical surface of a hollow sphere. The inner curved member 31 has a through hole formed through an inner central part thereof and hexagonal hole formed around the through hole. Nut 35 is fitted in the hexagonal hole.

The outer curved member 32 includes a cylindrical member 32a and a lid 32b screwed to the cylindrical member 32a. The cylindrical member 32a has a curved bottom 32c which is constituted by a curved surface composing a part of the spherical surface of the hollow sphere. The curved bottom 32c has a through hole. The lid 32b has a surface having a lock protrusion 32d and two hook pieces 32e all of which are formed integrally with one another. The hook piece 32e has a generally L-shaped section. The lock protrusion 32d is formed between the hook pieces 32e.

The guide piece 33 has the shape of a curved surface composing a part of the spherical surface of the hollow sphere. The guide piece 33 also has a flange 33a which is located around the curved surface and has a square outer shape. A circular opening 33b is formed in a central part of the curved surface. The curved surface of the guide piece 33 has a curvature radius that is larger than a curvature radius of a curved surface of the inner curved member 31 and smaller than a curvature radius of the curved surface 32c of the outer curved member 32. The circular opening 33b of the guide piece 33 has a radius that is set so as to be smaller than a maximum outer diameter of the curved surface of the inner curved piece 31 and so as to be smaller than a maximum inner diameter of the curved bottom 32c of the outer curved member 32.

The joint 30 is formed by overlapping a curved surface of the inner curved piece 31, a curved surface of the guide piece 33 and the curved bottom 32c of the outer curved member 32 and by inserting a bolt 34 into a through hole of the inner curved piece 31, an opening 33b of the guide piece 33 and the through hole of the curved bottom 32c of the outer curved member 32. A nut 35 is then attached to bolt 34 and the bolt 34 is tightened, so that the inner curved member 31 and the outer curved member 32 are assembled to the guide piece 33 so as to be slidable along the guide piece 33 in a right-left direction and an up-down direction.

The joint 30 thus includes the inner curved member 31, the guide piece 33 and the outer curved member 32 assembled integrally with one another by the bolt 34 and nut 35. Small screws 36 are inserted through two pairs of right and left or upper and lower through-holes formed through four corners of the flange 33a of the guide piece 33, respectively. The screws 36 are further screwed into the screw holes 22a of the connection piece 22 respectively, whereby the joint 30 is fixed to the C-shaped bracket 20.

The vehicle-mounted holder 10 constructed as described above is mounted in the car audio equipment accommodation recess 100 by using a car audio equipment mounting bracket 105 which is originally fixed in the recess 100 by bolts 104 for the mounting of car audio equipment. The bracket 105 has a generally C-shaped section and includes right and left sides 105a formed with a plurality of pairs of through holes 105b and positioning protrusions 105c. The holes 105b and protrusions 105c are arranged in the same manner as the screw holes 21b formed in the insertion piece 21 and the positioning holes 21c, and the same intervals as those of the screw holes 21b and the positioning holes 21c are employed.

The positioning protrusions 105c of the bracket 105 are fitted in the positioning holes 21c of the insertion piece 21, and small screws 106 are inserted through the holes 105b and then screwed into the screw holes 21b, respectively, whereby the vehicle-mounted holder 10 is fixed in the recess 100.

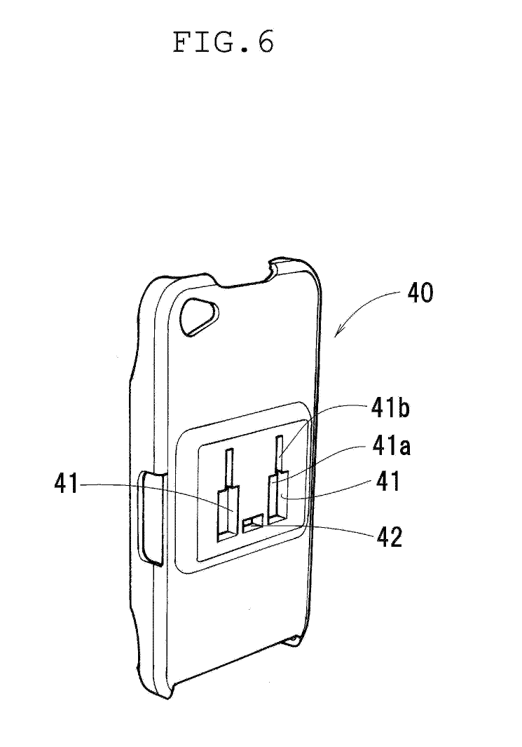

A holding member 40 as shown in FIG. 6 is detachably attached to the joint 30 of the vehicle-mounted holder 10 mounted in the accommodation recess 100 of the vehicle dashboard 103. The holding member 40 has an underside formed with two first lock holes 41 and a second lock hole 42. The hook pieces 32e formed on the lid 32b of the outer curved member 32 are adapted to engage the first lock holes 41 respectively and the lock protrusion 32d of the outer curved member 32 is adapted to engage the second lock hole 42.

Each first lock hole 41 includes a wider oblong hole 41a and a narrower oblong hole 41b. The second lock hole 42 is formed into a short oblong hole. When the hook pieces 32e are inserted through the oblong holes 41a and the holder 40 is then slid, the hook pieces 32e engage the oblong holes 41b respectively and the lock protrusion 32d engages the second lock hole 42, whereupon the holding member 40 is detachably attached to the joint 30. A smartphone or the like is detachably attachable to the holding member 40.

The width and the height of the bracket 20 are set according to the width and the height of the accommodation recess 100 formed in compliance with the 2DIN size in the vehicle-mounted holder 10. Accordingly, the vehicle-mounted holder 10 can be mounted in the accommodation recess 100 from which the genuine car audio equipment 101 has been detached. Consequently, driver's view and flow of air from the air conditioner can be prevented from being blocked by the vehicle-mounted holder 10. Furthermore, since the bracket 105 used to mount the car audio equipment is re-used, the vehicle-mounted holder 10 can be mounted in the accommodation recess 100 without modification of the dashboard 103.

Since the front opening 100a of the recess 100 is covered with the connection piece 22, the front opening 100a is not exposed even when the car audio equipment has been detached from the recess 100. Consequently, visual quality of the dashboard can be prevented from being degraded. Furthermore, the position of the joint 30 attached to the connection piece 22 by the small screws 36 is adjustable in the right-left direction and the up-down direction by selecting the screw holes 22a of the connection piece 22. This can improve the usability of the vehicle-mounted holder.

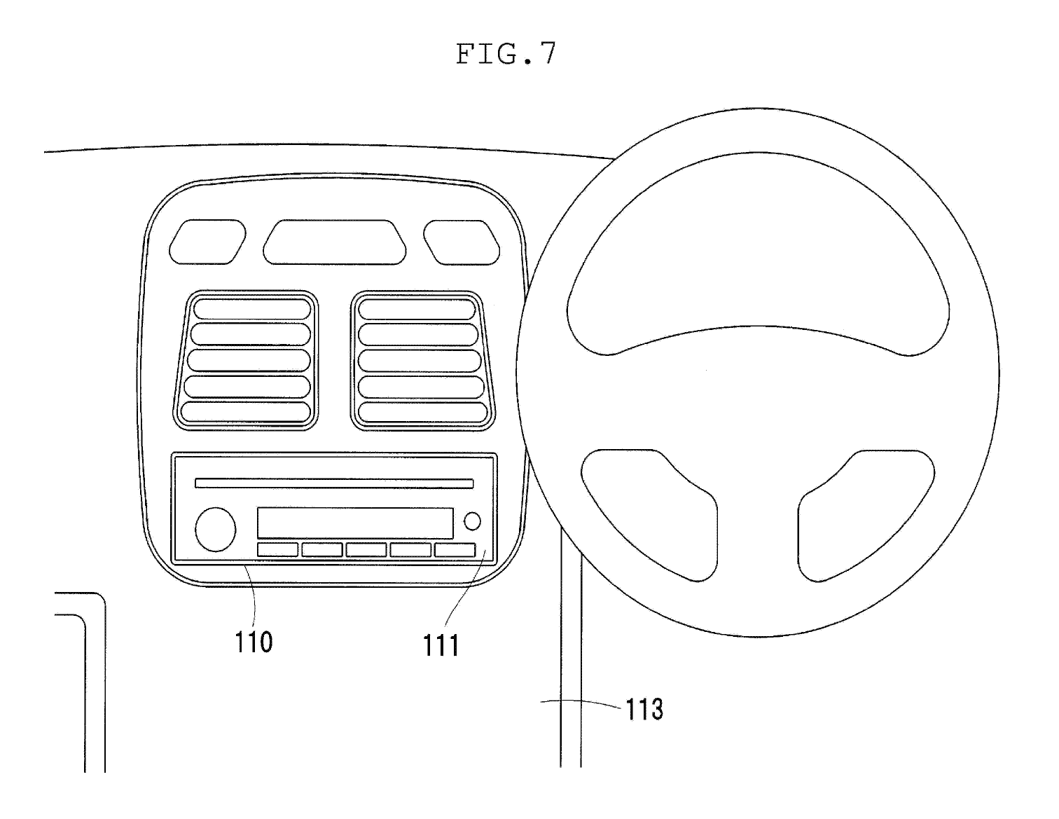

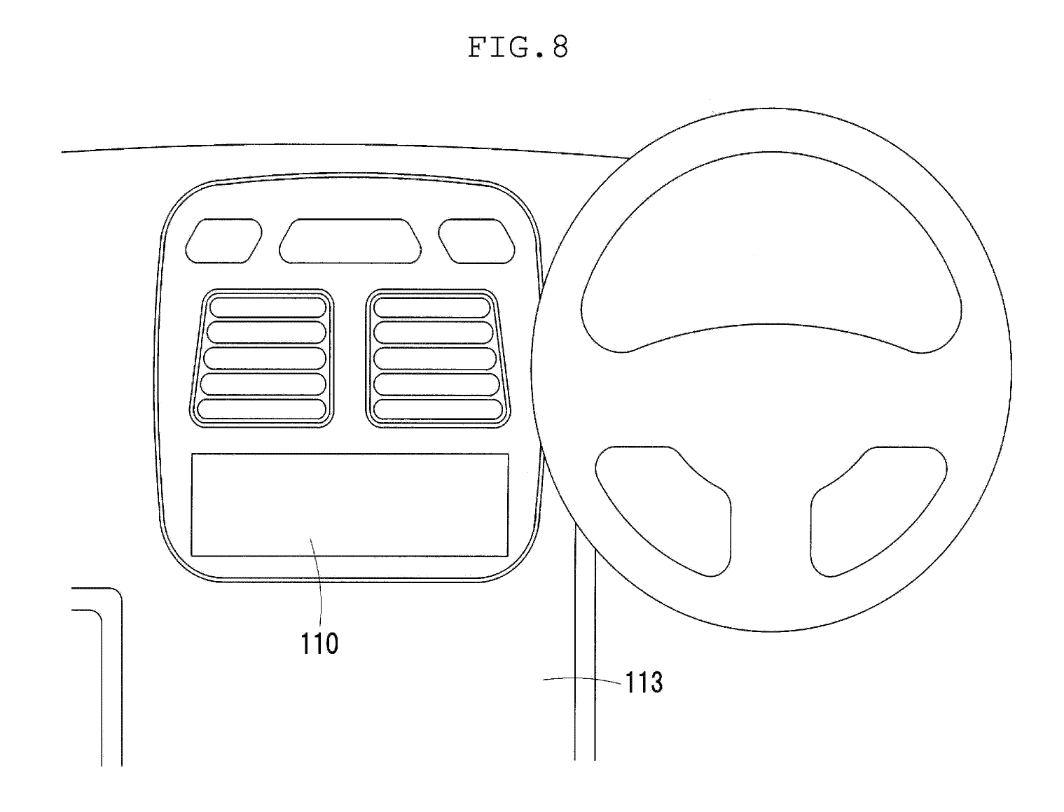

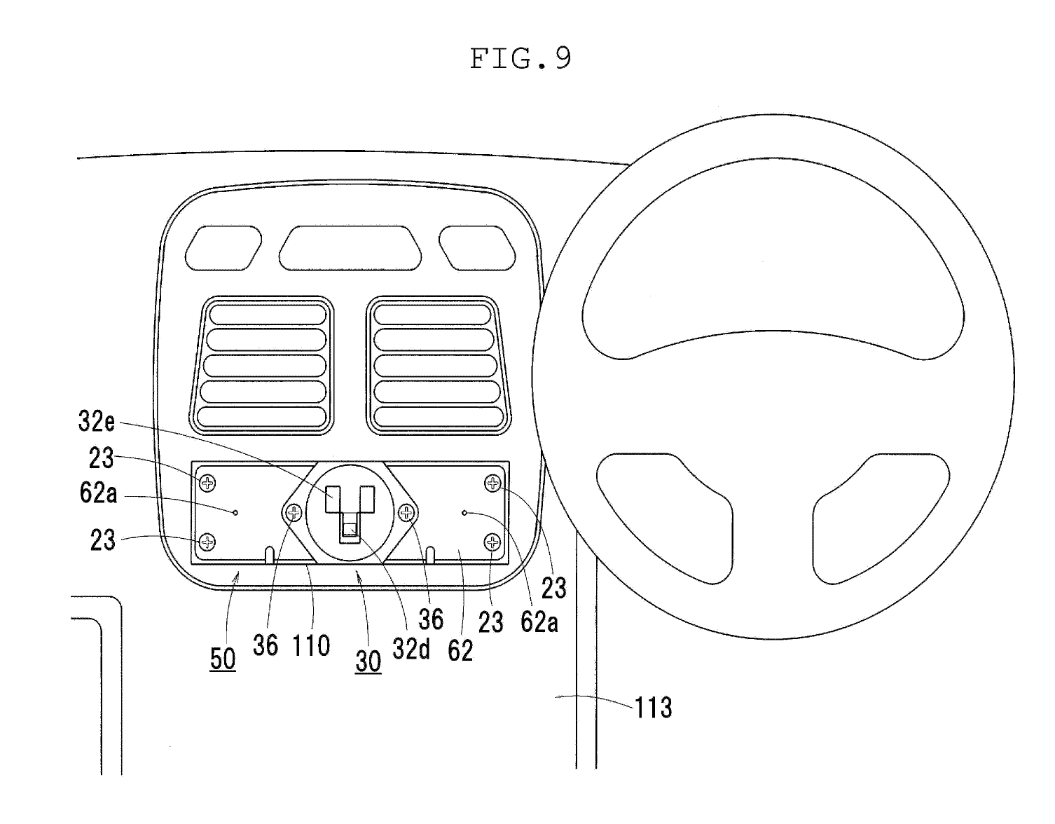

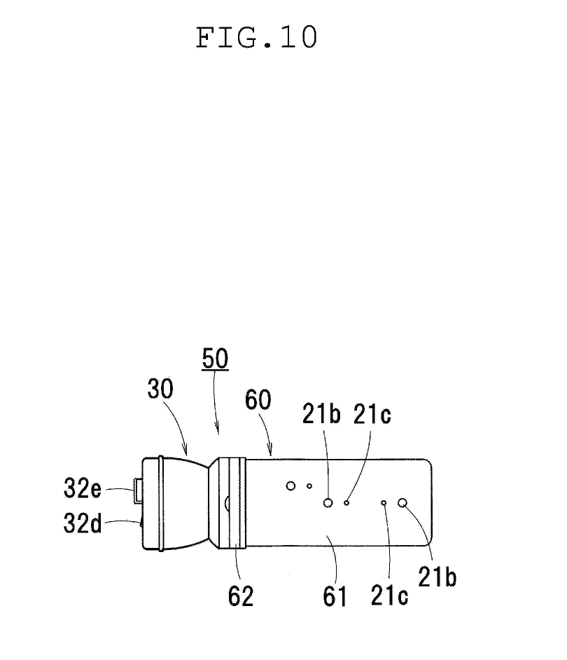

FIGS. 7 to 10 illustrate a vehicle-mounted holder 50 according to a second embodiment. FIG. 7 shows a vehicle's dashboard 113 having a car audio equipment accommodation recess 110 which complies with the 1DIN size and in which car audio equipment 111 is mounted. FIG. 8 shows the dashboard 113 having the recess 110 from which the car audio equipment 111 has been detached. FIG. 9 shows the vehicle-mounted holder 50 of the second embodiment, mounted in the recess 110 complying with the 1DIN size. FIG. 10 shows the vehicle-mounted holder 50.

The vehicle-mounted holder 50 includes a generally C-shaped bracket 60 and the joint 30. The bracket 60 includes the pair of right and left or upper and lower insertion pieces 61 and the connection piece 62 connecting between the insertion pieces 61. Each insertion piece 61 is formed with a plurality of, for example, four pairs of screw holes 21b and positioning smaller holes 21c.

The connection piece 62 has a plurality of screw holes 62a arranged in the right-left direction. The connection piece 62 has a width and a height both of which are set so that the connection piece 62 can be accommodated in the recess 110 complying with the 1DIN size and cover the front opening 110a of the recess 110. The other construction of the vehicle-mounted holder 50 according to the second embodiment is identical with that of the first embodiment. Accordingly, identical parts in the second embodiment are labeled by the same reference symbols as those in the first embodiment and the description of these parts will be eliminated.

In the vehicle-mounted holder 50 according to the second embodiment, the width and the height of the connection piece 62 are set so that the connection piece 62 can be accommodated in the recess 110 complying with the 1DIN size and so that the front opening of the recess 110 is covered with the connection piece 62. Consequently, the vehicle-mounted holder 50 can be mounted in the recess 110 formed in the dashboard 113 in compliance with the 1DIN size.

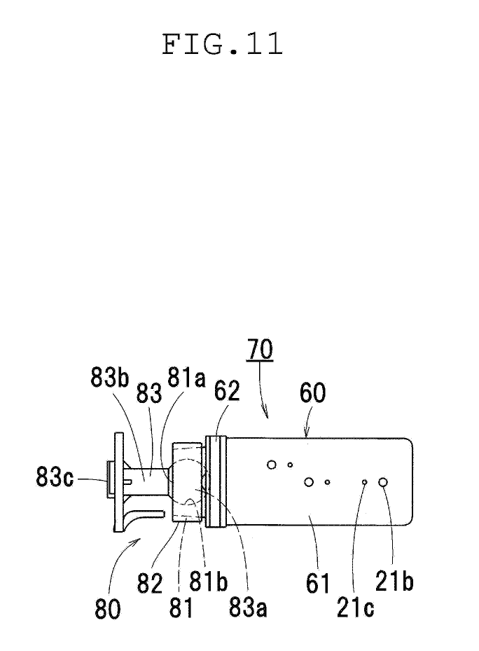

FIG. 11 illustrates a vehicle-mounted holder 70 according to a third embodiment. The vehicle-mounted holder 70 includes the generally C-shaped bracket 60 and a joint 80. The joint 80 includes a ball holding member 81, a sleeve 82 which is fitted with an outer periphery of the ball holding member 81 and a ball 83. The ball holding member 81 has one end secured to the connection piece 62 of the bracket 60. The ball holding member 81 has a hollow recess 81b formed therein so that a ball part 83a of the ball 83 is fitted in the recess 81b. The recess 81b has a first end secured to the connection piece 62 and a spreadable opening 81a formed in a second end thereof located opposite the first end secured to the connection piece 62. The outer periphery of the ball holding member 81 is formed so that an outer diameter thereof is gradually reduced more as the outer periphery comes near the opening 81a. A shaft 83b projects from the ball part 83a of the ball 83. The shaft 83b has an end provided with a hook piece 83c which engages the lock hole 41 of the holder as shown in FIG. 6.

The opening 81a is spread when the sleeve 82 is slid to the connection piece 62 side along an outer periphery of the ball holding member 81. The opening 81a is shrunk when the sleeve 82 is slid to the hook piece 83c side. The ball part 83a of the ball 83 is press fitted through the spread opening 81a of the ball holding member 81 into the hollow recess 81b. The ball 83 is assembled so that the ball part 83a is slidable in the right-left direction and in the up-down direction in the hollow recess 81b of the ball holding member 81 when the sleeve 82 is then slid to the hook piece 83c side such that the opening 81a is shrunk.

The other construction of the vehicle-mounted holder 70 according to the third embodiment is identical with that of the second embodiment. Accordingly, identical parts in the second embodiment are labeled by the same reference symbols as those in the second embodiment and the description of these parts will be eliminated.

The vehicle-mounted holder 70 according to the third embodiment can be mounted in the accommodation recess 110 complying with the 1DIN size. The direction of the holding member 40 mounted on the hook piece 83c can be adjusted in the right-left direction and in the up-down direction.

The foregoing description and drawings are merely illustrative and are not to be construed in a limiting sense. Various changes and modifications will become apparent to those of ordinary skill in the art. All such changes and modifications are seen to fall within the scope as defined by the appended claims.

What is claimed is:

1. A vehicle-mounted holder comprising:
a C-shaped bracket including a pair of right and left or upper and lower insertion pieces and a connection piece connecting between the insertion pieces; and
a joint having two ends, one of which is fixed to a surface of the connection piece and to the other of which a holding member holding a communication device is detachably attachable, the joint being capable of adjusting a direction of the holding member between an up-down direction and a right-left direction,
wherein the bracket has a width and a height both of which are set according to a width and a height of a recess provided in a dashboard of a vehicle for installation of car audio equipment having standardized width and height so that the right and left insertion pieces of the bracket can be secured to right and left walls of the recess or so that the upper and lower insertion pieces of the bracket can be secured to upper and lower walls of the recess, respectively.

2. The vehicle-mounted holder according to claim 1, wherein the recess has a front opening, and the connection piece has a width and a height both of which are set so that the opening of the recess is covered with the connection piece.

3. The vehicle-mounted holder according to claim 1, wherein:
the joint has a pair of right and left or upper and lower through holes;
the connection piece has a plurality of screw holes arranged along a widthwise or heightwise direction thereof;
the joint is fixed to the connection piece by screwing a pair of screws through the through holes of the joint into the screw holes of the connection piece respectively; and
the screw holes into which the screws are to be screwed are selected so that an attachment position of the joint to the connection piece is adjustable in a right-left direction or in an up-down direction.
